(19) United States
(12) Patent Application Publication
(10) Pub. No.: US 2006/0039069 A1
(43) Pub. Date: Feb. 23, 2006

(54) Polarized light separating element embedded with thin metallic wire

(75) Inventors: Narutoshi Hayashi, Niihama-shi (JP); Takashi Fujii, Niihama-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/204,374

(22) Filed: Aug. 16, 2005

(30) Foreign Application Priority Data
Aug. 20, 2004 (JP) 2004-240583

(51) Int. Cl. G02B 5/30

(52) U.S. Cl. 359/486; 359/483

(57) ABSTRACT

An object of the present invention is to provide a high-performance polarized light separating element having stable structure and superior durability, whose product with a large area can easily be manufactured. There is provided a polarized light separating element comprising a plurality of thin metallic wires 21, 21 embedded and arrayed in a planar substrate 10 so as to be parallel to each other, wherein the pitch (P) of the wires 21, 21 is 100 to 300 nm, the ratio (D/P) of the width (D) of the wires 21, 21 to the pitch (P) of the wires is 0.1 to 0.6, and the height (H) of the wires 21, 21 in a cross section orthogonal to a lengthwise direction of the wires is 50 to 500 nm. With regard to the wires 21, 21, a surface thereof may be covered with a metallic oxide film. The substrate 10 is preferably a polymeric resin film.

### BACKGROUND OF THE INVENTION

1. Field of the Invention

The present invention relates to a polarized light separating element used for a liquid crystal display device, a projection display device and a headlamp of an automobile.

2. Description of the Related Art

A polarized light separating element selectively transmits only linearly polarized light vibrating in a specific direction and reflects linearly polarized light vibrating in a direction orthogonal to the specific direction. The following have been known as such a polarized light separating element; an element made of a multilayer laminate of several kinds of polymeric films having different refractive anisotropy, and an element made of a metal wire grid. A polarized light separating element of a metal wire grid type is described, for example, in WO 00/079317 Publication (=Japanese Patent National Publication No. 2003-502758) and JP No. 10-73722 A. These polarized light separating elements of a metal wire grid type separate polarized light by reflecting linearly polarized light vibrating in a direction parallel to a wire grid and transmitting linearly polarized light vibrating in a direction orthogonal thereto.

A conventional technique for producing a semiconductor has been employed for manufacturing such a polarized light separating element of a metal wire grid type. Examples thereof include a method of using holographic interference lithography to form a structure having fine line and space in a photoresist and next transfer this structure to a metal film thereunder by ion beam etching; a method of directly using electron-beam lithography to form a resist pattern and next transfer the pattern to a metal film by reactive ion etching; a method of using another high-resolution lithographic technique including extreme ultraviolet lithography and X-ray lithography to manufacture a resist pattern; and a method of using another etching mechanism to transfer a pattern from a resist to a metal film. A polarized light separating element of a metal wire grid type to be manufactured by these methods can be achieved with high polarized light separative power for the reason that a fine structure thereof is accurately formed.

While a conventional metal wire grid is formed on a substrate surface, a structure of the metal wire grid is easily broken and inferior in durability. Also, a conventional metal wire grid is not easily applied to a larger area of 100 cm square or more by reason of being generally manufactured by batch processing.

### SUMMARY OF THE INVENTION

Thus, the object of the present invention is to provide a high-performance polarized light separating element having stable structure and superior durability, whose product with a large area can easily be manufactured.

The present invention provides a polarized light separating element comprising a plurality of thin metallic wires embedded and arrayed in a planar substrate so as to be parallel to each other, wherein the pitch (P) of the wires is 100 to 300 nm, the ratio (D/P) of the width (D) of the wires to the pitch (P) of the wires is 0.1 to 0.6, and the height of the wires in a cross section orthogonal to a lengthwise direction of the wires is 50 to 500 nm. Here, with regard to the thin metallic wires, a surface thereof may be covered with a metallic oxide film. A preferable planar substrate is a polymeric resin film.

A polarized light separating element according to the present invention has stable structure of a metal wire grid and superior durability, which element also is easily intended for achieving a larger area.

### BRIEF DESCRIPTION OF THE DRAWINGS

FIG. 1 is a perspective view schematically showing an example of a polarized light separating element of a metal wire grid type;

FIG. 2 is a cross-sectional schematic view showing an example of a polarized light separating element according to the present invention;

FIG. 3 is a cross-sectional schematic view showing another example of a polarized light separating element according to the present invention;

FIG. 4 is a cross-sectional schematic view showing a further example of a polarized light separating element according to the present invention;

FIG. 5 is a cross-sectional schematic view showing a still further example of a polarized light separating element according to the present invention;

FIG. 6 is a cross-sectional schematic view showing a still further example of a polarized light separating element according to the present invention;

FIG. 7 is a schematic perspective view for illustrating the concept of simulation; and

FIG. 8 is a view showing a model of a cell in simulation.

### DETAILED DESCRIPTION OF PREFERRED EMBODIMENTS

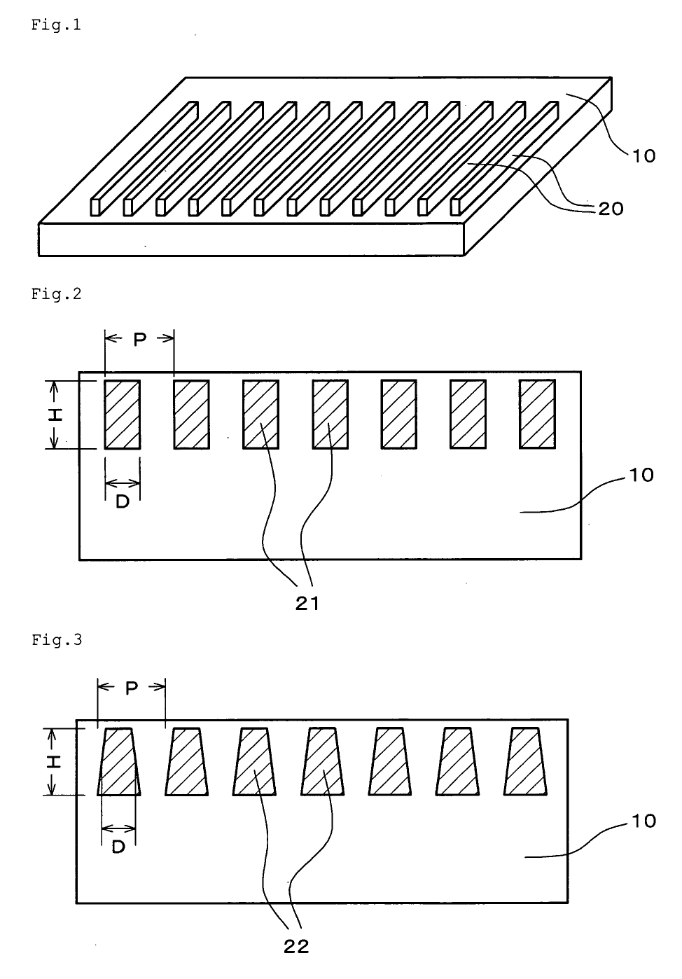

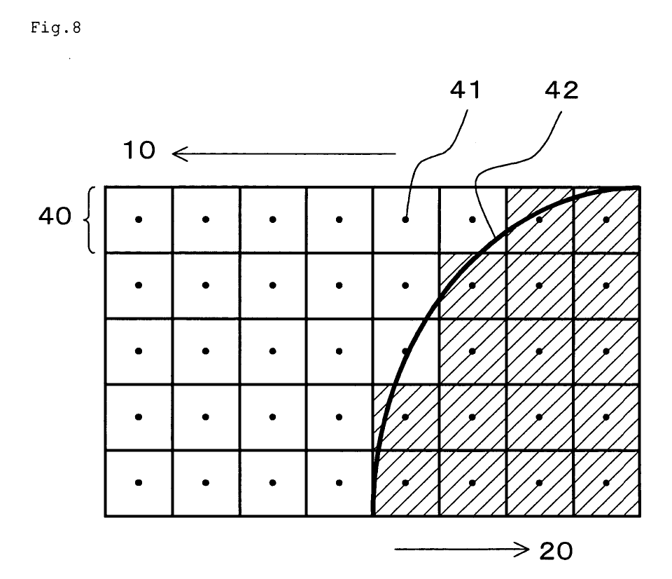

The present invention is hereinafter detailed while properly referring to attached Figures. FIG. 1 is a perspective view schematically showing an example of a polarized light separating element of a metal wire grid type, and FIGS. 2 to 6 are cross-sectional schematic views showing an example of a polarized light separating element according to the present invention. FIGS. 7 and 8 are explanatory views of a polarized light separating element embedded with thin metallic wires in the case of performing optical simulation; FIG. 7 is a schematic perspective view for illustrating the concept of simulation, and FIG. 8 is a view showing a model of a cell in simulation.

A polarized light separating element of a metal wire grid type is such that a plurality of thin metallic wires 20, 20 are arrayed in a planar substrate 10 so as to be parallel to each other, as shown in a schematic perspective view of FIG. 1. Conventionally, such thin metallic wires 20, 20 have been formed convexly on a surface of the planar substrate 10 by a lithographic technique etc. On the contrary, in the present invention, a polarized light separating element is constituted so that the thin metallic wires 20, 20 are embedded and arrayed in the 10.

Also with regard to the present invention, the pitch (P) of the wires 20, 20 is set at 100 to 300 nm, the ratio (D/P) of the width (D) to the pitch (P) of the wires 20, 20 is set at 0.1 to 0.6, that is, satisfies 0.1≦(D/P)≦0.6, and additionally the height (H) of the thin wires 20, 20 in a cross section orthogonal to a lengthwise direction thereof is set at 50 to 500 nm.

A glass plate and a polymeric resin film can be used as the planar substrate 10, preferably a polymeric resin film from the viewpoint of a rolled state having a long length and the achievement of a larger area. Examples of a polymeric resin film include an acrylic resin film, a polyester resin film, a polycarbonate resin film, a cyclic polyolefin resin film having structured unit derived from ring-opening or addition polymerization of norbornene or derivatives thereof, a polyolefin resin, a polyether sulfone resin film, and an epoxy resin film. Examples of a polyester resin film include polyethylene terephthalate and polyethylene butyrate. Examples of a cyclic polyolefin resin include “ARTON” sold by JSR Corporation, and “ZEONOR” and “ZEONEX” (any is a trade name) sold by OPTES Inc. or Nippon Zeon Co., Ltd. In the case of using a polymeric resin film, coefficient of linear expansion is preferably as low as that of glass from the viewpoint of stabilization of a shape.

The thickness of the planar substrate 10 is not particularly limited; for example, 1 μm to 5 mm, preferably 40 μm or more, or 500 μm or less. The planar substrate 10 preferably has high transparency and small change in dimensions under the conditions of heating and heat and humidity.

With regard to the thin metallic wires 20, 20 formed in the planar substrate 10, the pitch (P), namely, the interval between the arrayed thin metallic wires 20, 20 is set at 100 to 300 nm. When the pitch (P) of the thin metallic wires 20, 20 is less than 100 nm, an intended polarized light separating element is not easily manufactured, and it is difficult to obtain uniform properties. Meanwhile, if the pitch (P) of the thin metallic wires 20, 20 is more than 300 nm, diffraction is easily caused resulting in coloring.

The ratio (D/P) of the width (D) to the pitch (P) of the wires 20, 20 is set at 0.1 to 0.6. The ratio (D/P) of the width to the pitch of the wires is preferably 0.1 to 0.3. (D/P) less than 0.1 makes structure formation difficult and decreases polarized light separative power. Meanwhile, (D/P) more than 0.6 makes interferential action notable to color transmitted light, leading to an unpreferable situation.

The height (H) of the thin metallic wires 20, 20 in a cross section orthogonal to a lengthwise direction of the thin wires is set at 50 to 500 nm. The height (H) of the thin wires 20, 20 is preferably 100 nm or more, or 300 nm or less. The height less than 50 nm decreases polarized light separative power. Meanwhile, the height more than 500 nm makes structure formation difficult.

Examples of metal composing the thin metallic wires 20, 20 include aluminum, gold, silver and copper. Aluminum is preferable for the reason that reflected light is less colored and a metallic oxide layer is formed on a surface thereof for chemical stabilization.

Thus, a surface of the thin metallic wires may be covered with a metallic oxide film, such as a film made of an oxide of metal composing the thin wires. In the case of adopting aluminum as metal, an aluminum oxide layer is typically formed on a surface thereof in contact with air. The thickness of a metallic oxide film is typically 2 nm or more, preferably 10 nm or more. The space between the adjacent thin metallic wires may be filled up with a metallic oxide layer. When aluminum is covered with a metallic oxide layer such as aluminum oxide, wavelength dependence of transmitted light is decreased, leading to a preferable situation.

For example, the following methods can be adopted for embedding the thin metallic wires 20, 20 in the planar substrate 10;

(1) a method of forming the thin metallic wires 20, 20 on a surface of the planar substrate 10 to cover the surface with a material of the same kind as or a different kind from the support 10, and

(2) a method of forming a thin metallic film on the whole surface of the planar substrate 10 to thereafter oxidize the metal in a beltlike state and regard a portion of the metal remaining without being oxidized as the thin metallic wires 20, 20.

A proper method can be adopted for forming the thin metallic wires 20, 20 on a surface of the planar substrate 10, such as a method of previously forming an intended shape on a roll surface by nano imprinting method to transfer the concavo-convex shape by pushing the roll against a surface of the substrate 10 and thereafter embed metal in the concave portion. The thin metallic wires 20, 20 can be formed in a rolled film by adopting a method of transferring irregularities on a roll surface to a surface of the substrate, so that a larger area is easily achieved.

A proper method can be adopted for embedding metal in the concave portion thus formed on a surface of the substrate 10, such as a method of forming a metal layer by sputtering method and vacuum deposition method, and a method of embedding metal paste. In the case where a metal layer is formed not merely in the concave portion but also on a surface of the substrate, the metal on the convex portion of the substrate may be removed by abrading the surface, or only a metal wire grid formed in the concave portion may remain by oxidizing a surface of the metal to be changed into a metallic oxide. A metal wire grid can also be formed by forming a metal layer on the planar substrate 10 by deposition method and sputtering method to thereafter remove the metal portion in a beltlike or stripelike state.

In the case where a surface of the substrate 10 on which the thin metallic wires 20, 20 are formed is covered with a material of the same kind as or a different kind from the substrate 10, examples of the material include an acrylic resin, a polyester resin, a polycarbonate resin, a cyclic polyolefin resin having a structural unit derived from ring-opening or addition polymerization of norbornene or derivatives thereof, a polyolefin resin, a polyether sulfone resin, an epoxy resin, a silicone resin, an alkyd resin, and a fluororesin with low refractive index. In particular, resin with lower refractive index easily allows higher polarized light separation properties, leading to a preferable situation.

On the other hand, the constitution may be such that a cured resin layer is formed on a surface of a polymeric film, in which layer a metal wire grid is embedded. Examples of a cured resin layer are such as to have a refractive index in a range of approximately 1.3 to 1.6. Lower refractive index allows higher polarized light separative power, preferably a refractive index of 1.3 to 1.5. Examples of resin forming a cured resin layer include an acrylic resin, a polyester resin, a polycarbonate resin, a cyclic polyolefin resin having a structural unit derived from ring-opening or addition polymerization of norbornene or derivatives thereof, a polyolefin resin, a polyether sulfone resin, an epoxy resin, a silicone resin, an alkyd resin, and a fluororesin with low refractive index. The above-mentioned methods can properly be selected for a method of forming a metal wire grid in these cured resin layers.

The cross-sectional shape of the thin metallic wires forming a metal wire grid can be a rectangle, a square, a trapezoid, a triangle, a circle and an ellipse. Corners may be roundish. Shapes for easily allowing high polarized light separative power are a rectangle, a trapezoid, a triangle and an ellipse. The thin metallic wires 20, 20 may be formed in parallel on the same plane or formed at different depths, or further formed on plural planes.

Several examples of a polarized light separating element according to the present invention are shown in each of FIGS. 2 to 6 with a schematic view of a cross section orthogonal to a lengthwise direction of the thin metallic wires. An example shown in FIG. 2 denotes a state such that a plurality of the thin metallic wires 21, 21, whose cross section is approximately a rectangle of width D and height H, are embedded in the proximity of one surface of the planar substrate 10 in parallel in a row at a predetermined pitch P. In this example, the thin metallic wires 21, 21 are embedded so that a long side direction of a rectangle in a cross section of the thin metallic wires becomes a thickness direction of the planar substrate 10.

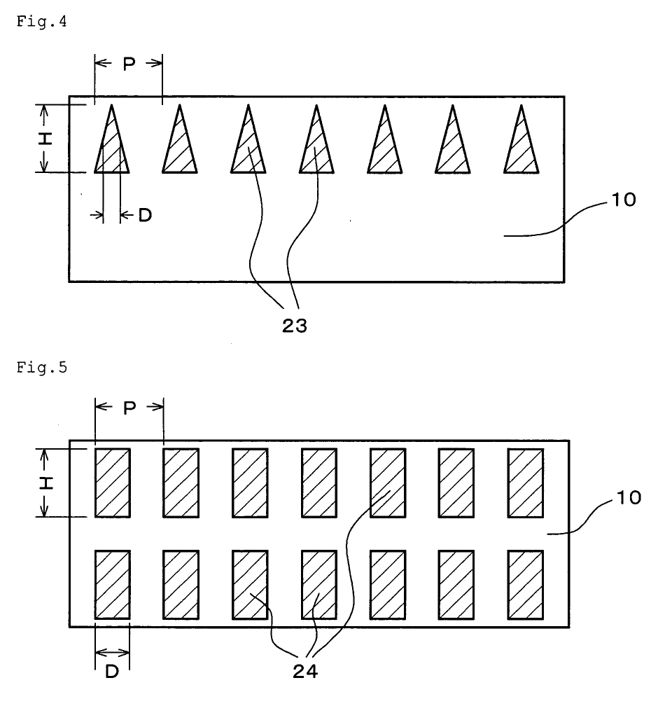

An example shown in FIG. 3 denotes a state such that a plurality of the thin metallic wires 22, 22, whose cross section is a trapezoid of height H, are embedded in the proximity of one plane of the planar substrate 10 in parallel in a row at a predetermined pitch P. In the case where the width differs in a height direction of a cross section of the thin metallic wires 22, 22 as shown in this example, it is preferred that an average value thereof, which is a lateral dimension in the central portion in a height direction in this example, is regarded as width D. Also in this example, the thin metallic wires are embedded so that a long side direction in a cross section of the thin metallic wires 22, 22 becomes a thickness direction of the planar support 10.

An example shown in FIG. 4 denotes a state such that a plurality of the thin metallic wires 23, 23, whose cross section is an isosceles triangle of height H, are embedded in the proximity of one surface of the planar substrate 10 in parallel in a row at a predetermined pitch P. Also in this case, it is preferred that a lateral dimension in the central portion in a height direction of a cross section of the thin metallic wires 23, 23 is regarded as width D in the same manner as FIG. 3. Also in this example, the thin metallic wires are embedded so that a long side direction in a cross section of the thin metallic wires 23, 23 becomes a thickness direction of the planar substrate 10.

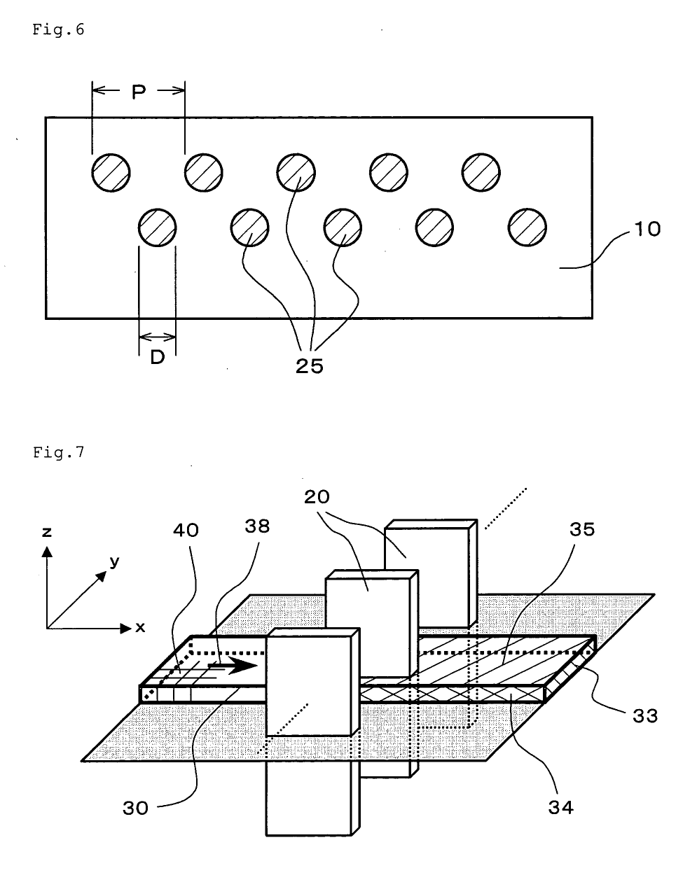

An example shown in FIG. 5 is the same as an example shown in FIG. 2 in that a plurality of the thin metallic wires 24, 24, whose cross section is approximately a rectangle of width D and height H, are embedded in the planar substrate 10 at a predetermined pitch P; however, these thin metallic wires 24, 24 are embedded in the proximity of one surface and in the proximity of the other surface of the planar substrate 10 in parallel in two rows in total. Also in this example, a long side direction of a rectangle in a cross section of the thin metallic wires 24, 24 becomes a thickness direction of the planar substrate 10.

In the case where the cross-sectional shape of the thin metallic wires is not isotropic as shown in FIGS. 2 to 5, a long side direction thereof is preferably set in a thickness direction of the planar substrate 10, thus a thickness direction of a polarized light separating element.

An example shown in FIG. 6 denotes a state such that a plurality of the thin metallic wires 25, 25, whose cross section is a circle of diameter D, are embedded in the planar substrate 10 in parallel in two rows at a predetermined pitch P. The thin metallic wires 25, 25 in two rows are located alternately in view from a surface of the planar substrate 10. Thus, in the case of alternately disposing the thin metallic wires 25, 25 in two rows, it is preferred that pitch P is denoted by the interval between the thin metallic wires 24, 24 in each of the rows to determine a value of (D/P) provided by the present invention. In this example, a cross section of the thin metallic wires is a circle, so that a height thereof is equal to diameter D of a circle.

In the case where the thin metallic wires 20 to 25 are arrayed in the planar substrate 10 at regular intervals, it is preferred that each of the intervals is regarded as pitch (P); however, in the case where the intervals are not necessarily regular, it is preferred that an average interval between the thin metallic wires in a direction parallel to a surface of the planar substrate 10 is regarded as pitch (P) to determine a value of (D/P) provided by the present invention. In the case where pitches (P) are not regular, all of them are more preferably set in a range of 100 to 300 nm. Similarly, in the case where the widths of the thin metallic wires 20 to 25 are not regular, it is preferred that an average value thereof is regarded as width (D) to determine a value of (D/P). In the case where values of (D/P) in each of the adjacent thin metallic wires are not regular, the values of (D/P) are more preferably set in a range of 0.1 to 0.6 in all of the adjacent thin metallic wires. Further, in the case where the heights (H) of the thin metallic wires 20 to 25 are not regular, it is preferred that an average value thereof is set in a range of 50 to 500 nm provided by the present invention. In the case where the heights (H) are not regular, all of them are more preferably set in a range of 50 to 500 nm.

A polarized light separating element of the present invention constituted as described above allows high polarized light separative power. Here, polarized light separative power is defined by the following expression (1).

$$P = \sqrt{\frac{Tp - Tc}{Tp + Tc}} \qquad ( 1 )$$

In the expression (1), Tp and Tc are luminosity factor corrected values of transmittance in transmission direction Tp(λ) and transmittance in reflection direction Tc(λ) in each wavelength λ, which are defined by the following expressions (2) and (3), respectively.
Tp(λ)=[kp(λ)×kp(λ)+kc(λ)×kc(λ)]/2 (2)
Tc(λ)=kp(λ)×kc(λ) (3)

Here, kp(λ) is transmittance of linearly polarized light orthogonal to the thin metallic wires (in a direction in which incident light is mainly transmitted), kc(λ) is transmittance of linearly polarized light parallel to the thin metallic wires (in a direction in which incident light is mainly reflected), and Tp(λ) and Tc(λ) calculated from kp(λ) and kc(λ) are corrected on luminosity factor by the following expression (4) to calculate Tp and Tc.

$$T = \frac{{\int }_{400}^{700} S ( λ ) y ( λ ) T ( λ ) ⅆ λ}{K} \qquad ( 4 )$$

In the expression (4), S(λ) is intensity distribution of C light source (according to JIS Z 8701), y(λ) is luminosity correction factor (according to JIS Z 8701), T(λ) is Tp(λ) or Tc(λ), and K is a constant calculated by the following expression (5).

$$K = {\int }_{400}^{700} S ( λ ) y ( λ ) ⅆ λ \qquad ( 5 )$$

### EXAMPLES

An example of a polarized light separating element of a metal wire grid type according to the present invention is hereinafter described on the basis of the results of simulation.

First, the outline of simulation is described. The properties of a polarized light separating element of a metal wire grid type are calculated by using Finite Difference Time Domain: FDTD method as an electromagnetic wave analysis method. Examples of literature for detailing this analysis method include the following literature 1.

Literature 1: “Electromagnetic Field And Antenna Analysis By FDTD Method” written by TOHRU UNO, CORONA PUBLISHING CO., LTD. (1998)

The reference to this literature allows information enough to perform simulation to be described below, and publicly known literature exists in multitude in addition thereto. Examples of the initial literature include the following literature 2.

Literature 2: K. S. Yee; IEEE Trans. Antennas Propagat. 14, 302 (1966)

A Gaussian pulse plane wave of 1/e half width 88 nm was used as incident light in FDTD method. This pulse has a wavelength component over a visible light range. This pulse is made to perpendicularly enter a polarized light separating element of a metal wire grid type to calculate time change of an electromagnetic field. Expressions used for calculation and a method of calculation are described in the above-mentioned Literature 1. An incident electromagnetic pulse wave was set to include polarized light parallel to the thin metallic wires and polarized light orthogonal to the thin metallic wires at a ratio of 1:1. Electromagnetic fields Ex(t), Ey(t), Ez(t), Hx(t), Hy(t) and Hz(t) at time t in a location after passing through a metal wire grid can be obtained by the calculation. Here, Ex(t) signifies a component in x-axis direction of an electric field vector, which is a value at time t. Similarly, Ey(t) and Ez(t) signify components in y-axis direction and z-axis direction of an electric field at time t, respectively. Also, Hx(t), Hy(t) and Hz(t) are components in x-axis direction, y-axis direction and z-axis direction of a magnetic field vector at time t, respectively.

Next, calculation of wavelength spectrum of transmittance is described. The results by FDTD method are denoted as time change of an electromagnetic field, which thereby does not directly allow a value of transmittance at each wavelength. Then, a time change waveform is subject to fast Fourier transform (FFT) to thereby obtain frequency component of a pulse made to enter and frequency spectrum of a pulse transmitted through a metal wire grid with regard to an electric field and a magnetic field. A rectangle was used for a window function in FFT for the reason that incident electromagnetic wave conditions were a pulse wave, not a continuous wave. Optical frequency f and wavelength λ in a vacuum satisfy a relation of λ=c/f by the velocity of light c, so that wavelength spectrum can be obtained. In order to obtain energy transmittance of each polarized light, a Poynting vector component in a transmission direction with regard to each of polarized light parallel to the thin metallic wires and polarized light orthogonal to the thin metallic wires is separately calculated from each of frequency amplitudes Ex(f), Ey(f), Ez(f), Hx(f), Hy(f) and Hz(f) obtained by FFT. That is, regarding a traveling direction of light as x axis, a width direction of the thin metallic wires as y axis, and a lengthwise direction of the thin metallic wires as z axis, energy Sxy(f) of polarized light orthogonal to the thin metallic wires and energy Sxz(f) of polarized light parallel to the thin metallic wires are calculated by Sxy(f)=Ey(f)×Hz(f) and Sxz(f)=Ez(f)×Hy(f), respectively. In simulation, calculation was performed for each of the case with a metal wire grid and the case without a metal wire grid. The results of calculating in the case with a metal wire grid and the case without a metal wire grid are denoted as a subscript 1 and a subscript 0 respectively as follows.
kc(f)=Sxz₁(f)/Sxz₀(f)
kp(f)=Sxy₁(f)/Sxy₀(f)

The calculated kc(f) and kp(f) were converted into kc(λ) and kp(λ) on the basis of the above-mentioned relation of λ=c/f.

‘Drude model’ was used in this FDTD method for the reason that the physical properties of metal need to be taken in calculation. This model describes optical properties of metal and has inertia of free electrons and a value of mean free path as parameters. A parameter of aluminum was used hereinafter. The scope of the present invention and the applicable scope of simulation are not limited to aluminum. Drude model parameter used in simulation was determined by fitting a value described in the following literature 3 on complex permittivity of aluminum.

Literature 3: Hagemann, H. J., Gudat, W., Kunz, C.; DESY SR-74/7, Hamburg (1974)

With regard to aluminum, however, an influence of transition between bands appears on the short wavelength side of a visible light range. Transition between bands is a phenomenon derived from electrons bound by an atomic nucleus, and it is conceived that the transition scarcely affects a polarized light separative function of a metal wire grid on which free electrons have a dominant influence. Then, Drude model parameter was determined from complex permittivity in an infrared region in which bound electrons have less influence and the behavior of free electrons in aluminum has a great influence to perform calculation by FDTD method. Parameters used in the calculation are as follows.

(FDTD Calculation Parameter)

Boundary Conditions

Perfectly Matched Layer (PML) absorbing boundary conditions: 8 layers tertiary, a reflection coefficient of 1×10⁻¹⁰

Periodic boundary conditions: cell size dx=5 nm, time step dt=9×10⁻¹⁸ sec

(Drude Parameter)

In an expression of Drude represented by the following (6), plasma angular frequency ωₚ was set at 1.88×10¹⁶ sec⁻¹ and collision frequency ν_{c} was set at 1.13×10¹⁴ sec⁻¹.

$$ɛ ( ω ) = 1 - \frac{{ω}_{p}^{2}}{ω ( ω + {iv}_{c} )} \qquad ( 6 )$$

Here, e is complex permittivity and is represented as a function of optical angular frequency ω. Optical angular frequency ω is related to optical frequency f by ω=2 pf. i signifies imaginary number. Drude model was taken in calculation by Piecewise Linear Recursive Convolution method (PLRC method). The meaning of a calculation parameter of FDTD method described herein and PML method and PLRC method are detailed in the above-mentioned literature 1.

The concept of simulation performed as described above is shown in FIG. 7 by a schematic perspective view. In this example, the thin metallic wires 20 having a rectangular cross section and an infinite length are embedded in the support to constitute a polarized light separating element, regarding a thickness direction of the polarized light separating element (a height direction of a rectangular cross section in the thin metallic wires 20) as x axis, a periodic array direction of the thin metallic wires 20 (a width direction of a rectangular cross section in the thin metallic wires 20) as y axis, and a lengthwise direction of the thin metallic wires 20 as z axis. Also, the thin metallic wires 20 are regarded as being periodically arrayed infinitely in y-axis direction.

FDTD calculating area 30, which includes an area of the thin metallic wires 20 and is long in x-axis direction (in FIG. 7, a rectangular parallelepiped area surrounded in a thick line and long in a lateral direction), is set. In this FDTD calculating area 30, a plane 33 perpendicular to x-axis direction (in a rectangular parallelepiped in FIG. 7, a plane with right-lower oblique lines in the right-hand side area) becomes an application plane of PML absorbing boundary conditions. A plane 34 perpendicular to y-axis direction (in a rectangular parallelepiped in FIG. 7, a plane with right-upper and right-lower oblique lines in the right-hand side area) and a plane 35 perpendicular to z-axis direction (in a rectangular parallelepiped in FIG. 7, a plane with right-upper oblique lines in the right-hand side area) become application planes of periodic boundary conditions. X-axis direction of this FDTD calculating area 30 is regarded as a direction of propagation of light 38, and this FDTD calculating area 30 is divided into a multitude of cells 40 composed of a cube having the height in z-axis direction thereof as one side.

A model of a cell in simulation is shown in FIG. 8. In this Fig., one cell is shown by a square 40, and barycentric coordinates thereof are shown by a black spot 41. A cross section of the thin metallic wires is a circle or an ellipse, and an interfacial boundary 42 between the thin metallic wires and the support is a circular arc shown in a thick line. The inside of the interfacial boundary 42 shown in a circular arc is the thin metallic wires 20, while the outside is the support 10. It is determined whether a cell is regarded as a medium made of the thin metallic wires 20 or a medium made of the substrate 10, depending on barycentric coordinates 41 thereof are on the side of the thin metallic wires 20 or the side of the substrate 10. In FIG. 8, simulation is performed on the conditions that cells with oblique lines are regarded as a medium made of the thin metallic wires 20, and white cells without oblique lines are regarded as a medium made of the substrate 10.

Next, the details of calculation model are described. With regard to FDTD, an optical constant in accordance with a structure to be calculated is assigned to each cell to perform calculation. For example, in the case of performing simulation for columnar metallic wire array of radius r, an optical constant of metal is assigned to cubical cells located correspondingly to the inside of a metal wire grid, and an optical constant (permittivity) of polymeric resin is assigned to other cells. Thus, the shapes of the thin wires, such as a column, a square pole, a triangle pole or a trapezoid in a cross section, were taken in simulation.

A calculating area prepared in FDTD method was subject to an array of approximately 1,600 cells in x-axis direction in which light is propagated, approximately 50 cells (according to the pitch of the thin metallic wires) in y-axis direction in which the thin wires are periodically arrayed, and one cell in z-axis direction in which the thin metallic wires extend. Then, calculation was performed by applying PML absorbing boundary conditions to a calculating area interfacial boundary 33 perpendicular to x-axis direction, and periodic boundary conditions to an interfacial boundary 34 perpendicular to y-axis direction and an interfacial boundary 35 perpendicular to z-axis direction. That is, simulation is performed, such that the thin metallic wires 20 are arrayed infinitely in y-axis direction and extend infinitely in z-axis direction.

### Example 1

Thin metallic wires are made of aluminum, and the cross-sectional shape thereof is approximately a rectangle having a width of 78 nm and a height of 150 nm. The whole surface of these thin wires is covered with an aluminum oxide film having a thickness of 20 nm. These thin wires are embedded at a pitch of 150 nm in one surface of a polymeric film having a refractive index of approximately 1.5 in a state such that a height direction of a cross section of the thin wires is a thickness direction of the film and the thin wires are arrayed in a row so as to be parallel to each other. The ratio (D/P) of the width to the pitch of the thin wires is 78/150=0.52. This polarized light separating element has approximately a cross-sectional shape shown in FIG. 2. The polarized light separative power of this polarized light separating element is approximately 89%.

### Example 2

Thin metallic wires are made of aluminum, and the cross-sectional shape thereof is a trapezoid (wedge) having a long side of 50 nm, a short side of 30 nm and a height of 150 nm. These thin wires are embedded at a pitch of 150 nm in one surface of a polymeric film having a refractive index of approximately 1.5 in a state such that a height direction of a trapezoid in a cross section of the thin wires is a thickness direction of the film and the thin wires are arrayed in a row so as to be parallel to each other. The ratio (D/P) of the width to the pitch of the thin wires in the central portion in a height direction of a trapezoid is 40/150=0.26. This polarized light separating element has approximately a cross-sectional shape shown in FIG. 3. The polarized light separative power of this polarized light separating element is approximately 89%.

### Example 3

Thin metallic wires are made of aluminum, and the cross-sectional shape thereof is an isosceles triangle having a base of 80 nm and a height of 150 nm. These thin wires are embedded at a pitch of 150 nm in one surface of a polymeric film having a refractive index of approximately 1.5 in a state such that a height direction of an isosceles triangle in a cross section of the thin wires is a thickness direction of the film and the thin wires are arrayed in a row so as to be parallel to each other. The ratio (D/P) of the width to the pitch of the thin wires in the central portion in a height direction of a triangle is 40/150=0.26. This polarized light separating element has approximately a cross-sectional shape shown in FIG. 4. The polarized light separative power of this polarized light separating element is approximately 89%.

### Example 4

Thin metallic wires are made of aluminum, and the cross-sectional shape thereof is an isosceles triangle having a base of 80 nm and a height of 150 nm. These thin wires are embedded at a pitch of 150 nm in one surface of a polymeric film having a refractive index of approximately 1.3 in a state such that a height direction of an isosceles triangle in a cross section of the thin wires is a thickness direction of the film and the thin wires are arrayed in a row so as to be parallel to each other. The ratio (D/P) of the width to the pitch of the thin wires in the central portion in a height direction of a triangle is 40/150=0.26. This polarized light separating element also has approximately a cross-sectional shape shown in FIG. 4. The polarized light separative power of this polarized light separating element is approximately 94%.

A polarized light separating element of the present invention is useful as a brightness enhancement film for effectively utilizing light by transmitting linearly polarized light vibrating in a predetermined direction and reflecting linearly polarized light vibrating in a direction orthogonal thereto to return to the backlight side for reflection among natural light from a light source in a liquid crystal display device. The polarized light separating element is also useful as a replacement of a polarizing beam splitter (PBS) to be employed for a projection display device and an element for efficiently taking linearly polarized light out of a headlamp of an automobile. With regard to any of them, the polarized light separating element can efficiently take out only polarized light vibrating in one direction stably for a long time among natural light emitted from a very strong light source. This polarized light separating element has stable structure of a metal wire grid and superior durability, and a product thereof with a large area can easily be manufactured, which element, therefore, is particularly useful for a display device with a large area.

What is claimed is:

1. A polarized light separating element comprising;
a plurality of thin metallic wires embedded and arrayed in a planar substrate so as to be parallel to each other; wherein
a pitch (P) of the thin is 100 to 300 nm;
a ratio (D/P) of a width (D) of the wires to a pitch (P) of the wires is 0.1 to 0.6; and
a height of the wires in a cross section orthogonal to a lengthwise direction of the wires is 50 to 500 nm.

2. A polarized light separating element according to claim 1, wherein a surface of the thin metallic wires is covered with a metallic oxide film.

3. A polarized light separating element according to claim 1, wherein the planar substrate is a polymeric resin film.
